(19) United States
(12) Patent Application Publication
(10) Pub. No.: US 2023/0214093 A1
(43) Pub. Date: Jul. 6, 2023

(54) PAGING CONTENT FOR USER INTERFACE DISPLAY

(71) Applicant: International Business Machines Corporation, Armonk, NY (US)

(72) Inventors: Yoshio Horiuchi, Hiratsuka-shi (JP); Mayumi Goto, Ayase (JP); Sho Ayuba, Tokyo (JP)

(21) Appl. No.: 17/567,353

(22) Filed: Jan. 3, 2022

(51) Int. Cl. G06F 3/0483; G06F 3/04812; G06F 3/0482

(52) U.S. Cl. CPC G06F 3/0483; G06F 3/0482; G06F 3/04812

(57) ABSTRACT

A computer-implemented method includes receiving instructions to display contents containing multiple items, and calculating a number of pages in which the multiple items are divided. The method further includes creating several user interface elements, each user interface element assigned to a page. The method further includes determining a range information of each page, wherein the range information of the page indicates a start and end of a range of the items included on the page. The method further includes, for each of the user interface elements, adding the range information of the page assigned to the user interface element, and displaying the user interface elements with respective range information.

### BACKGROUND

The present invention generally relates to computer technology, particularly, user interfaces and specifically paging content for displaying via a user interface.

Today, computing devices, such as desktops, laptops, tablet-computers, phones, etc., have become ubiquitous. Such computing devices are used for almost everything such as communication, word processing, banking, e-commerce, e-learning, browsing, entertainment, record keeping, healthcare, and several other fields and applications. Further, computing devices come in several different forms, desktop, laptop, tablet, phone, etc. and even in each of those forms, the display size varies. While various user interface adaptability measures are available, improvement to operation of user interface is desirable.

### SUMMARY

According to one or more embodiments of the present invention, a computer-implemented method includes receiving instructions to display contents containing multiple items, and calculating a number of pages in which the multiple items are divided. The method further includes creating several user interface elements, each user interface element assigned to a page. The method further includes determining a range information of each page, wherein the range information of the page indicates a start and end of a range of the items included on the page. The method further includes, for each of the user interface elements, adding the range information of the page assigned to the user interface element, and displaying the user interface elements with respective range information.

According to one or more embodiments of the present invention, a system includes a memory, and one or more processing units coupled with the memory. The one or more processing units are configured to perform a method to display contents containing multiple items. Performing the method includes calculating a number of pages in which the items are divided. The method further includes creating several user interface elements, each user interface element assigned to a page. The method further includes determining a range information of each page, wherein the range information of the page indicates a start and end of a range of the items included on the page. The method further includes, for each of the user interface elements, adding the range information of the page assigned to the user interface element, and displaying the user interface elements with respective range information.

According to one or more embodiments of the present invention, a computer program product includes a computer-readable storage medium that has computer-executable instructions stored thereupon. The computer-executable instructions when executed by a processor cause the processor to perform a method to display contents containing multiple items. Performing the method includes calculating a number of pages in which the items are divided. The method further includes creating a several user interface elements, each user interface element assigned to a page. The method further includes determining a range information of each page, wherein the range information of the page indicates a start and end of a range of the items included on the page. The method further includes, for each of the user interface elements, adding the range information of the page assigned to the user interface element, and displaying the user interface elements with respective range information.

The above-described features can also be provided at least by a system, a computer program product, and a machine, among other types of implementations.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example scenario of a user interface using paging according to one or more embodiments of the present invention;

FIG. 2 depicts an example of another user interface according to one or more embodiments of the present invention;

FIG. 3 depicts a block diagram of a system to provide effective paging for user interfaces to navigate large content according to one or more embodiments of the present invention;

FIG. 4 depicts a flowchart of a method to provide effective paging for user interfaces to navigate large content according to one or more embodiments of the present invention;

FIG. 5 depicts a flowchart of a method to generate range information according to one or more embodiments of the present invention;

FIG. 6 depicts an example scenario according to one or more embodiments of the present invention;

FIG. 7 depicts another example scenario according to one or more embodiments of the present invention; and

FIG. 8 depicts a computing system according to one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Technical solutions are described herein to improve operation of user interfaces (UI) in computing systems, and particularly paging of content that is to be displayed on a user interface.

Typically, when it is not possible to display the entirety of contents on one screen, i.e., a single view, a UI enables a page-by-page display, in which a user switches from one page (i.e., view, portion, section, segment of the content) to another page. In some cases the UI may include page-switching UI elements, such as buttons, links, etc., that facilitate a user to change the page. Alternatively, or in addition, the UI enables users to scroll through the content (e.g., top-down scroll, left-right scroll, etc.). It should be noted that even during scrolling, although a different UI element, such as a scroll bar, may be used (instead of page-switching UI elements) the underlying mechanism or operation may still be the same as switching pages. The scrolling is used to provide, to the user, a feeling of a smooth view, using “pseudo pages.”

Such “paging” of content to be displayed on the UI also improves performance of the computing system because the entire content does not have to be obtained (e.g., over communication network) and loaded into memory. In some cases, the content that is to be displayed may also have to be processed before displaying, e.g., colored, scaled, transformed, formatted, etc. Rather, paging improves the performance of the computing system because only the content that the user desires to view can be obtained, loaded, and processed (instead of the entirety of the content).

However, paging the content poses a technical problem of usability because the user is forced to press the UI element, e.g., next button, scroll button, etc., to obtain a desired item from the content. Further, the user is unable to determine, at a glance how far the content has to be scrolled, i.e., how many pages to move, to view the desired item from the content. Here, an “item” from the content can be text, image, media, code, digital file, link, user-id, or any other electronic content, and should not be construed in any manner to limit the scope of the present invention.

Embodiments of the present invention address the technical challenges with the usability of user interfaces, which are technical challenges rooted in computing technology. Embodiments of the present invention provide improvements to computing technology by facilitating user interfaces that facilitate a user to scroll contents that do not fit in a single page (or view) with minimal number of interactions (such as clicks, touches, button-presses, etc.). one or more embodiments of the present invention facilitate the user to view a selectable view of the entire contents, enabling the user to directly navigate to a desired page, without having to scroll or search through irrelevant content.

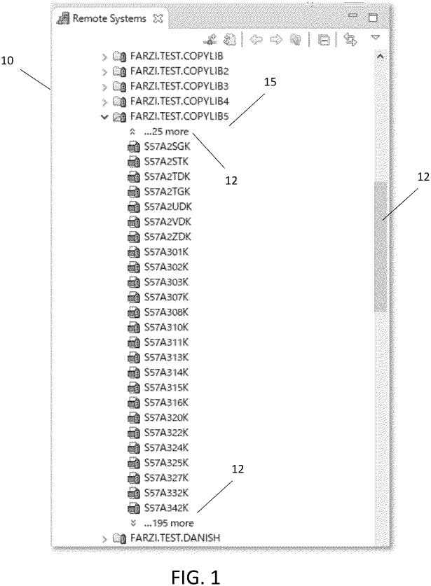

FIG. 1 depicts an example scenario of a user interface using paging according to one or more embodiments of the present invention. A UI 10 is shown to depict content 15, which can be scrolled using a UI element 12, in this case a scroll-bar. In addition, in the UI 10, the user can interact with UI elements 12 (“... 25 more,” “... 195 more”), which can referred to as “paging buttons.” It is understood that the UI 10 can include other components such as, menu bar, buttons, etc., in one or more embodiments of the present invention. Further, it is understood that in other embodiments of the present invention, the UI 10 can use any other type of UI element 12 such as buttons, links, etc., instead of the scroll-bar, to scroll through the content 15. In the example shown in FIG. 1, the content is a list of members in a partitioned data set (PDS), such as the one in the Z/OS®. Any other type of content 15 can be used in other embodiments of the present invention.

In the particular scenario shown, more than 10,000 members may exist in one PDS, thus making scrolling through the content 15 using the UI element 12 impractical and time consuming. Further, loading the such large amounts of content 15 for display in the UI 10 can be resource intensive, causing the UI 10 to stutter or be unresponsive to user interactions. The paging forward using the paging buttons (FIG. 1) pose the same technical challenges. For example, in some cases the UI 10 shows 25 members at a time, and the user does not know how many interactions (e.g., clicks) are required to get the desired item.

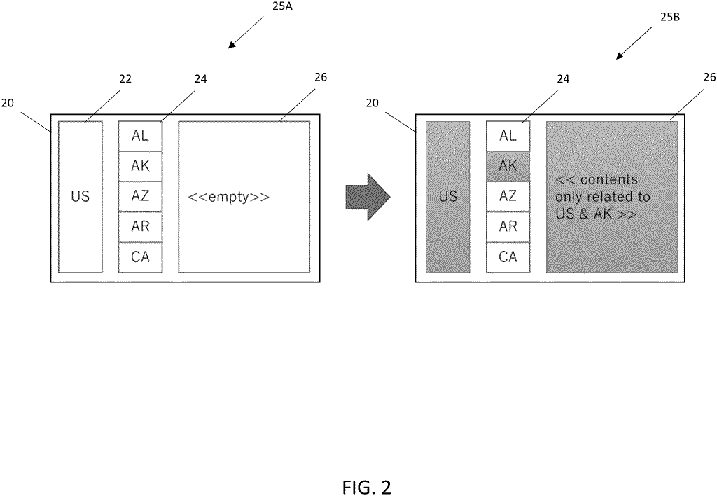

Conventional or existing solutions to address such technical challenges with the UI 10 include a method such as online analytical processing (OLAP) drill-down to display detailed data. This method allows users to sequentially obtain detailed information by drilling down into each category. FIG. 2 depicts an example of an OLAP-based UI 20. Here, selecting an element 22 (e.g., US) from a first category (or hierarchy) causes a list of elements 24 (e.g., list of states) from a second category to be displayed. Selecting an element from the list of elements 24 can cause further information 26 to be displayed. In one or more embodiments of the present invention, additional categories can exist causing the drill-down to include additional UI elements such as 22, 24 to be displayed based on a selection from a previous category in the hierarchy. In FIG. 2, the view 25B shows the UI 20 with multiple selections made in the UI 20 as shown in the view 25A.

However, even in this method to update the UI 20, if the content 15 is large (e.g., 10,000 or more items), obtaining the items from the content 15 to populate the UI elements 22, 24, 26, the technical challenges of obtaining the items in a page-wise manner still exist, if the list of items in any level is large (e.g., 10,000 or more).

Another conventional technique is to provide the user with a “search” function. The user can search for a desired item from the content 15, and presumably, the desired item can be found without operations such as paging. While searching circumvents the above recited technical challenges (rather than solving them), such search functionality requires that the user to have a certain level of accurate knowledge about attributes of the desired item such as, a part of a file name, to be able to search for it. In practice, the may remember such attributes ambiguously, and in that case, settings for search keys are made loose so that various items can be hit. This may result in a large number of outputs of items in the search result, thus, leaving the technical challenge unsolved. Further, the user may also ambiguously remember certain items in the vicinity of the desired item and in some cases wish to search the desired item by looking at listed items. In this case, the search function is unhelpful to address the user’s needs.

Embodiments of the present invention address the technical challenge by facilitating the user to vide the desired item. Embodiments of the present invention provide improvements over existing techniques. Embodiments of the present invention provide a practical application to facilitate the user to navigate large content, for example, with a large number (e.g., 1,000, 10,000 or more) number of items, with optimized (reduced) number of interactions (e.g., clicks, touches, or other forms of navigation) with the UI. Embodiments of the present invention provide practical application to provide a navigable optimized (i.e., improved) UI in such cases with large content to be navigated. Embodiments of the present invention provide improvements computing technology, particularly, user interfaces.

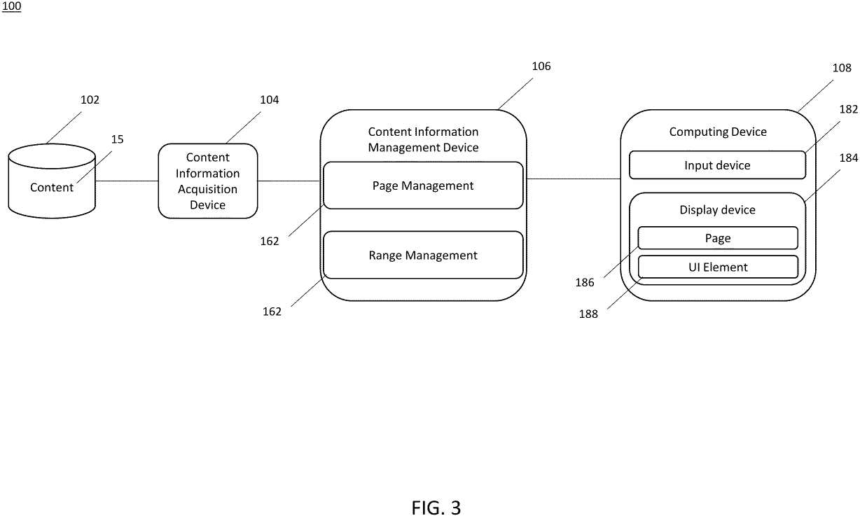

FIG. 3 depicts a block diagram of a system to provide effective paging for user interfaces to navigate large content according to one or more embodiments of the present invention. The system 100 includes a data store 102, a content information acquisition device 104, a content information management device 106, and a computing device 108, among other components. It should be noted that the components that are shown maybe combined in one or more embodiments of the present invention. For example, the content information acquisition device 104 and the content information management device 106 may be part of a server computer. Any other combination of the components is possible in other embodiments of the present invention.

The data store 102 stores the content 15. The data store 102 can be a database, a storage disk (e.g., hard disk, flash drive, solid state drive, etc.), or any other form of storage device and or media that includes the content 15. In one or more embodiments of the present invention, the data store 102 can be a distributed storage.

The content information acquisition device 104 facilitates obtaining items from the content 15 to be displayed. In some embodiments of the present invention, the content information acquisition device 104 sends commands / instructions to the data store 102 to obtain the items from the content 15, metadata (e.g., number of items, size of items (e.g., number of characters, memory-size, etc.), etc.), and other information about the content 15.

The content information management device 106 receives the information from the content information acquisition device 104 and uses the information to determine how the content is to be rendered by the computing device 108. The content information management device 106 also receives information about the computing device 108, such as the type of a display device 184, resolution of the display device 184, etc. Based on the information about the computing device 108 and the information about the content 15, the content information management device 106 can determine information to be rendered by the computing device 108 in the form of one or more pages 186 and one or more UI elements 188.

The computing device 108 can be any type of computer such as, a desktop, a laptop, a tablet, a phone, a wearable, or any other such device. The computing device 108 includes, among other components, an input device 182 and a display device 184. The input device 182 can be a keyboard, a mouse, a touchscreen, a joystick, or any other type of input device. The display device 184 can be a monitor, a touchscreen, or any type of a display device.

The components shown in FIG. 3 can communicate with each other in a wired or wireless manner. It is understood that the system 100 can include several other components such as, communication modules, processing modules, memory modules, etc., which are not shown.

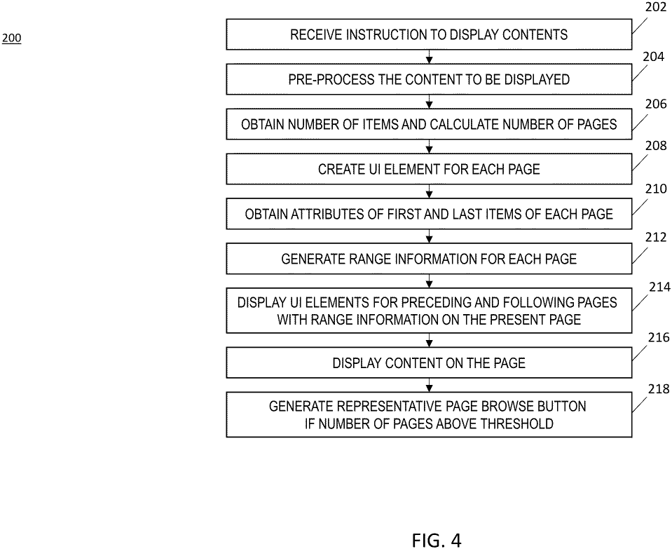

FIG. 4 depicts a flowchart of a method to provide effective paging for user interfaces to navigate large content according to one or more embodiments of the present invention. In one or more embodiments of the present invention, the system 100 implements or executes the method 200 that is shown. It is understood that the sequence of operations of the method 200 can vary from what is shown in the flowchart of FIG. 4 without limiting one or more embodiments of the present invention. Further, one or more operations of the method 200 can be performed in parallel (i.e., concurrently) in one or more embodiments of the present invention.

In one or more embodiments of the present invention, the content 15 includes one or more items that are to be displayed via the display device 184. As noted herein, the items can be any type of data, such as a list of members in a PDS, a list of digital files in a folder/directory, a list of directories, a list of users, a list of stock keeping units, or any other type of items that are to be displayed. The items do not have to be a list, and in other embodiments of the present invention, can include a large text or any other type of data (e.g., a book, a database, etc.) that is to be rendered via the display device 184.

In one or more embodiments of the present invention, at block 202, instruction is received to display the content 15 via the display device 184. For example, a user of the computing device 108, through interactions with the UI 10 via the display device 184 and the input device 182 requests the content 15 to be displayed on the display device 184. Other possibilities can also exist, such as, receiving an instruction from a computer program (not shown) to display the content 15 on the display device. The examples herein are described under the premise that the items to be displayed are sorted alphabetically; however, any other type of sorting or organization of the content 15 can be used in other embodiments of the present invention.

In one or more embodiments of the present invention, at block 204, the data that is to be displayed is pre-processed. The pre-processing can be performed by the data store 102 in some embodiments of the present invention. Alternatively, or in addition, the pre-processing can be performed by any other component such as, the content information acquisition device 104. Examples of pre-processing can include, but are not limited to, sorting, filtering, etc.

At block 206, the number of items to be displayed is determined and the number of pages required for displaying those many items is calculated. The number of items to be displayed can be determined by the content information acquisition device 104, in one or more embodiments of the present invention. Further, based on that information, a page management module 162 of the content information management device 106 calculates the number of pages. In one or more embodiments of the present invention, the page management module 162 also has the information about the resolution, zoom-level, etc. of the display device 184 to determine how many items can be displayed in a single page on the display device 184.

At block 208, the UI element 188 for page browsing corresponding to each page (hereinafter referred to as a “page browse button”) is created and added to each page 186 to be displayed. The UI element 188 can be any type of UI element such as a button, a link, etc.

At block 210, the content information acquisition device 104 obtains attributes of the first item and the last item assigned to each page 186. The attributes can include a filename, a timestamp (e.g., creation date, last modified date, etc.), or any other attribute that can be quantified and/or sortable. Some other examples of attributes can include but not limited to a weight, cost, ranking, number of good or bad reactions (e.g., reviews/ratings, likes/dislikes, etc.), number of comments, brightness (for pictures or images), image resolution, file size, etc.

At block 212, the content information management device 106 generates range information 164 for each page 186 based on attributes of items of each respective page 186 and its immediately preceding/following pages 186. For example, for page K, immediately preceding page is page K-1, and an immediately following page is page K+1.

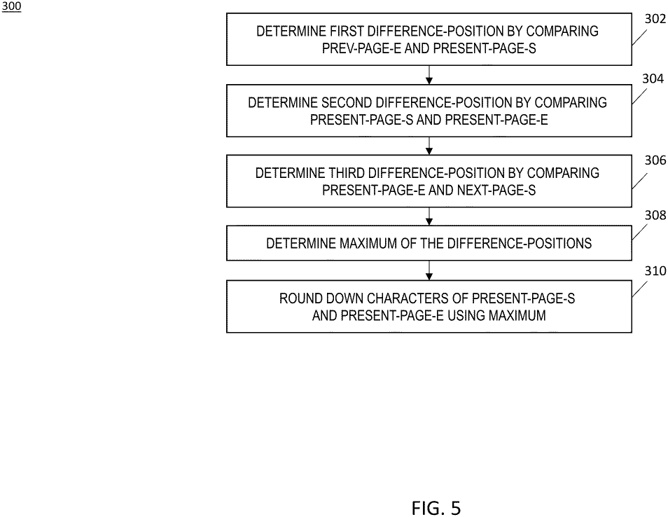

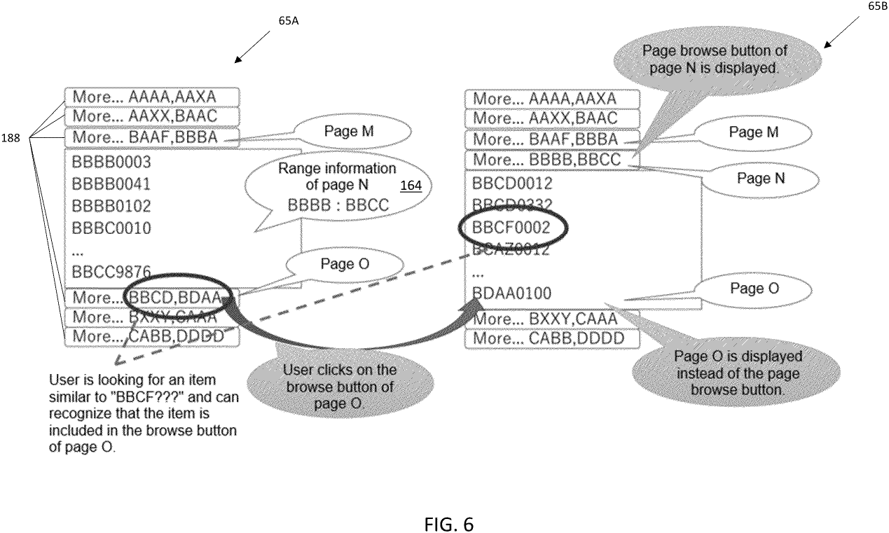

FIG. 5 depicts a flowchart of a method 300 to generate range information 164 according to one or more embodiments of the present invention. The method 300 is now described using the example in FIG. 6. In FIG. 6, several pages 186 are displayed, including three sequentially adjacent pages referred to as page M, page N, and page O.

The method 300 uses the acquired attributes of the first and last items of a page 186 to determine range information 164 for that page 186. Attributes of first and last items included in a page N are referred to as Ns (short for N-start) and Ne (N-end), respectively. Hence, the range information 164 may be expressed as “(Ns:Ne).” Note that the attributes in the example scenario herein are presumed to be alphabetically sorted as mentioned herein, and that in other embodiments of the present invention, the sorting can be performed based on any other attribute.

In the present example, consider that the page management 162 provides that Ns = “BBBB0003,” and Ne = “BBCC9876.” Accordingly, the range information 164 is set as: Range information = “BBBB0003:BBCC9876.” The range information 164 allows easy recognition of whether an item to be desirably displayed is included in a page 186 corresponding to that range information 164. For example, in the present example, it is understood that an item whose attribute is “BBBC0001” is included in the page 186 with the above range information 164.

In one or more embodiments of the present invention, a part of a character string of an attribute can be omitted when determining the range information 164. For example, using the same notation used above, an attribute of a last item of the preceding page M is Me (M-end) and an attribute of a first item of a following page O is Os (O-start). Here, page M is followed by page N is followed by page O, and page N is the present page, i.e., the page 186 that is being displayed on the display device 184. Consider that Me = “BBBA9900,” and Os = “BBCD0012.”

In method 300, character strings of adjacent attributes are compared to detect positions of first different characters and then select a maximum-difference position number among them. At block 302, comparison is made between Me and Ns to determine a first difference position. In the present example scenario, the first different position is 4 (from left). At block 304, Ns and Ne are compared to determine a second difference position, in this case 3. At block 306, Ne and Os are compared to determine a third difference position, in this case 4.

At block 308, the maximum-difference position number is determined by comparing the first, second, and third different position numbers. In the present example, the maximum-difference position number is 4.

At block 310, characters of Ns and Ne beyond the maximum-difference position number of character position are rounded down to set the range information 164. In the example, the range information 164 is updated, by partially omitting the characters based on rounding, to range information = “BBBB:BBCC.” The updated range information 164 facilitates users to understand, with less character information, that an item identified by an attribute (e.g., “BBBC0001”) is included in the present page 186 and an item identified by another attribute (e.g., “BBBA80000”) is not included in the present page 186.

In one or more embodiments of the present invention, instead of omitting, the characters following the maximum-difference position number are represented differently (using character size, color, font, etc.) from characters before the maximum-difference position number. The range information 164 is displayed on the UI elements 188 on the display device 184. In one or more embodiments of the present invention, a first portion of the range information 164 on the user interface element 188 is displayed using first visual attributes (e.g., color, font, size, etc.), and a second portion of the range information is displayed using second visual attributes. The first and second portions may be demarcated by the maximum-different position number. Alternatively, or in addition, in one or more embodiments of the present invention, the range information 164 is adjusted to remove a portion of the range information 164 (rounding and omitting) before adding the range information 164 to the user interface element 188 for display.

Referring to the method 200, at block 214, the display device 184 is updated to render on the page 186, the page browse buttons (UI elements 188) corresponding to the preceding and the following pages along with the range information. For example, for the page K, the page browse buttons and range information from the pages K-1 and K+1 are also displayed. The range information 164 is displayed with the page browse buttons (UI element 188). The range information 164 is displayed after omitting the rounded characters. In one or more embodiments of the present invention, the range information 164 is displayed with the page browse buttons by adjusting the attributes of the characters after the maximum-position difference number in the range information 164.

Each UI element 188 displays the range information 164 for the respective corresponding page 186. The user can select a UI element 188 (e.g., click, touch, etc.) and open the corresponding page 186. For example, in the scenario of FIG. 6, consider that the user is looking for an item similar to BBCF???, where the ‘?” denotes a value that the user is not sure about. Based on the range information 164 displayed on each of the UI elements 188, the user can select the UI element 188 of page O in the view 65A.

In response, the UI is updated as shown in the view 65B. In the view 65B, page O is displayed (instead of page N), and the UI element 188 corresponding to page N is displayed with the range information 164 for page N. Also, the UI element of page O, which the user selected, is not shown anymore (because page O itself is the present page).

At block 216, the page 186 is updated to also render the items from the content 15. It should be noted that the page browse buttons and range information may be generated asynchronously and displayed in sequential order of generation in one or more embodiments of the present invention. The page 186 is updated based on a selection from the user of the one or more UI elements 188.

Further, at block 218, if number of UI elements 188 is above a predetermined threshold (e.g., 10, 15, 20, etc.) a representative page browse button (i.e., another UI element 188) is generated. The representative page browse button combines several page browse buttons (UI elements 188).

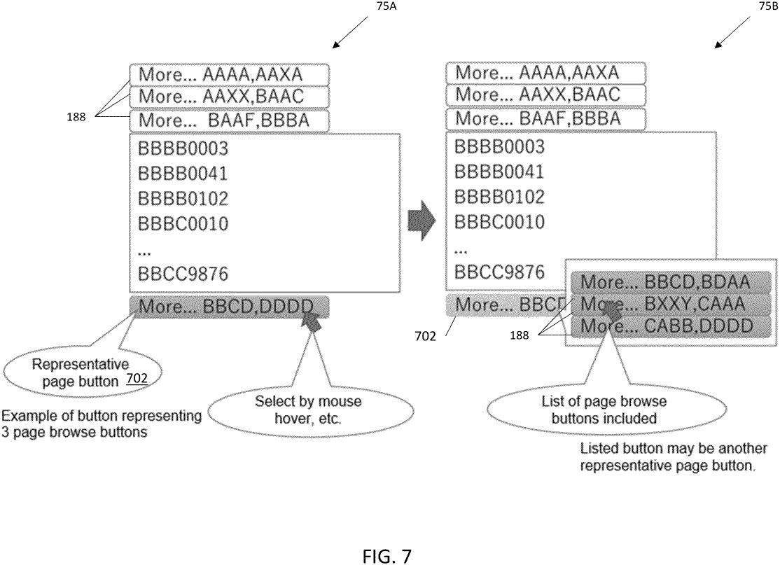

FIG. 7 depicts an example representative page browse button 702 according to one or more embodiments of the present invention. When the number of pages, and in turn, the number of UI elements 188 (page browse buttons) to be shown on the display device 184 is more than (or equal to) the predetermined threshold, a UI element (e.g., a button, a link, etc.) collectively showing several page browse buttons 188 of adjacent pages is dynamically created by the system 100. This collection of page browse buttons is referred to herein as a “representative page button,” 702 and it is understood that any other term may be used to refer to the dynamic UI element.

The representative page button 702 is assigned a range information 164 in the same manner as any of the page browse buttons 188 (described herein). The range information 702 is obtained from an attribute of a first item of a first page and an attribute of a last item of a last page that are included in the representative page browse button 702.

As shown in FIG. 7, the page browse buttons 188 of the pages 184 included in the representative page browse button are displayed upon selection of the representative page browse button 702 by the user. The selection can be a UI interaction such as, click, touch, hover, etc.

In one or more embodiments of the present invention, the representative page browse button 702 may further include another representative page browse button 702 if the number of page browse buttons 702 exceeds the threshold. In one or more embodiments of the present invention, the threshold number of page browse buttons 188 inside a representative page browse button 702 used to determine if another embedded representative page browse button 702 is to be generated, can be different (e.g., a second predetermined threshold).

Embodiments of the present invention accordingly address the technical challenge of usability of user interfaces with large amount of items in the content to be displayed. Arrangement of several page browse buttons having range information allows users to quickly identify and reach a required page. The range information is generated only from attributes of a part of items of a page, thus causing no reduction of performance and achieving enhanced usability. One or more embodiments of the present invention are also applicable to browsing datasets and PDS members in the remote systems view of Z/OS®. One or more embodiments of the present invention are further applicable to various fields using other applications (such as web applications) having a paging concept.

Embodiments of the present invention facilitate optimizing content browsing by performing a method that includes calculating the number of required pages by dividing the number of entire contents by the number of displayable contents on a screen. Further, the method includes obtaining attributes (e.g., content name, timestamp, etc.) of first and last contents for each of the calculated number of pages. Further, the method includes generating range information for each page based on the first and last attributes. Further, the method includes displaying a page browse button containing the range information for each page on the screen. The method realizes quicker access to desired contents, because users do not need to scroll the screen or search a page on the spur of the moment due to no range information.

Alternatively, or in addition, the method can include generating and displaying, in place of the page browse button, a representative button containing multiple page browse buttons, wherein the contained multiple page browse buttons are displayed in response to a user pressing down the representative button.

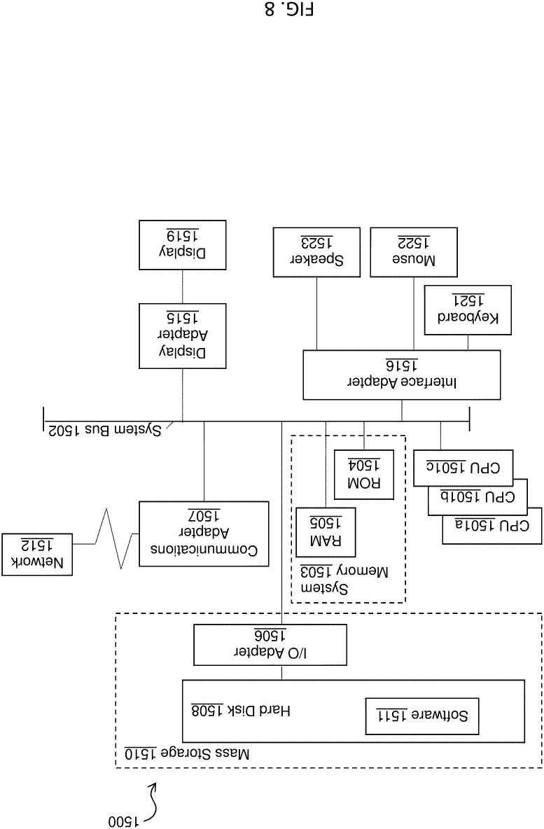

Turning now to FIG. 8, a computer system 1500 is generally shown in accordance with an embodiment. The computer system 1500 can be a computing device, server, or any other component of the system described herein, or the system itself. The computer system 1500 can be an electronic, computer framework comprising and/or employing any number and combination of computing devices and networks utilizing various communication technologies, as described herein. The computer system 1500 can be easily scalable, extensible, and modular, with the ability to change to different services or reconfigure some features independently of others. The computer system 1500 may be, for example, a server, desktop computer, laptop computer, tablet computer, or smartphone. In some examples, computer system 1500 may be a cloud computing node. Computer system 1500 may be described in the general context of computer system executable instructions, such as program modules, being executed by a computer system. Generally, program modules may include routines, programs, objects, components, logic, data structures, and so on that perform particular tasks or implement particular abstract data types. Computer system 1500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, the computer system 1500 has one or more central processing units (CPU(s)) 1501a, 1501b, 1501c, etc. (collectively or generically referred to as processor(s) 1501). The processors 1501 can be a single-core processor, multi-core processor, computing cluster, or any number of other configurations. The processors 1501, also referred to as processing circuits, are coupled via a system bus 1502 to a system memory 1503 and various other components. The system memory 1503 can include a read only memory (ROM) 1504 and a random access memory (RAM) 1505. The ROM 1504 is coupled to the system bus 1502 and may include a basic input/output system (BIOS), which controls certain basic functions of the computer system 1500. The RAM is read-write memory coupled to the system bus 1502 for use by the processors 1501. The system memory 1503 provides temporary memory space for operations of said instructions during operation. The system memory 1503 can include random access memory (RAM), read only memory, flash memory, or any other suitable memory systems.

The computer system 1500 comprises an input/output (I/O) adapter 1506 and a communications adapter 1507 coupled to the system bus 1502. The I/O adapter 1506 may be a small computer system interface (SCSI) adapter that communicates with a hard disk 1508 and/or any other similar component. The I/O adapter 1506 and the hard disk 1508 are collectively referred to herein as a mass storage 1510.

Software 1511 for execution on the computer system 1500 may be stored in the mass storage 1510. The mass storage 1510 is an example of a tangible storage medium readable by the processors 1501, where the software 1511 is stored as instructions for execution by the processors 1501 to cause the computer system 1500 to operate, such as is described herein below with respect to the various Figures. Examples of computer program product and the execution of such instruction is discussed herein in more detail. The communications adapter 1507 interconnects the system bus 1502 with a network 1512, which may be an outside network, enabling the computer system 1500 to communicate with other such systems. In one embodiment, a portion of the system memory 1503 and the mass storage 1510 collectively store an operating system, which may be any appropriate operating system, such as the z/OS or AIX operating system from IBM Corporation, to coordinate the functions of the various components shown in FIG. 8.

Additional input/output devices are shown as connected to the system bus 1502 via a display adapter 1515 and an interface adapter 1516 and. In one embodiment, the adapters 1506, 1507, 1515, and 1516 may be connected to one or more I/O buses that are connected to the system bus 1502 via an intermediate bus bridge (not shown). A display 1519 (e.g., a screen or a display monitor) is connected to the system bus 1502 by a display adapter 1515, which may include a graphics controller to improve the performance of graphics intensive applications and a video controller. A keyboard 1521, a mouse 1522, a speaker 1523, etc. can be interconnected to the system bus 1502 via the interface adapter 1516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 1500 includes processing capability in the form of the processors 1501, and, storage capability including the system memory 1503 and the mass storage 1510, input means such as the keyboard 1521 and the mouse 1522, and output capability including the speaker 1523 and the display 1519.

In some embodiments, the communications adapter 1507 can transmit data using any suitable interface or protocol, such as the internet small computer system interface, among others. The network 1512 may be a cellular network, a radio network, a wide area network (WAN), a local area network (LAN), or the Internet, among others. An external computing device may connect to the computer system 1500 through the network 1512. In some examples, an external computing device may be an external webserver or a cloud computing node.

It is to be understood that the block diagram of FIG. 8 is not intended to indicate that the computer system 1500 is to include all of the components shown in FIG. 8. Rather, the computer system 1500 can include any appropriate fewer or additional components not illustrated in FIG. 8 (e.g., additional memory components, embedded controllers, modules, additional network interfaces, etc.). Further, the embodiments described herein with respect to computer system 1500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
receiving instructions to display contents comprising a plurality of items;
calculating a number of pages in which the plurality of items are divided;
creating a plurality of user interface elements, each user interface element assigned to a page;
determining a range information of each page, wherein the range information of the page indicates a start and end of a range of the items included on the page;
for each of the plurality of user interface elements, adding the range information of the page assigned to the user interface element;
combining two or more of the user interface elements into a representative user interface element in response to a number of the user interface elements exceeding a predetermined threshold; and
displaying one or more of the plurality of user interface elements, including the representative user interface element, with respective range information.

2. The computer-implemented method of claim 1, further comprising displaying items of an Nth page.

3. The computer-implemented method of claim 2, wherein, in response to selection of a user interface element assigned to an Oth page, displaying items of the Oth page, and displaying, instead of the Nth page, a user interface element assigned to the Nth page.

4. (canceled)

5. The computer-implemented method of claim 1, wherein, in response to a selection of the representative user interface element, the two or more of the user interface elements are displayed.

6. The computer-implemented method of claim 1, wherein the range information for an Nth page is determined based on attributes of items on the Nth page, (N-1)th page, and (N+1)th page.

7. The computer-implemented method of claim 1, wherein the range information is adjusted to remove a portion of the range information before adding the range information to the user interface element.

8. The computer-implemented method of claim 1, wherein a first portion of the range information on the user interface element is displayed using first visual attributes, and a second portion of the range information is displayed using second visual attributes.

9. A system comprising:
a memory; and
one or more processing units coupled with the memory, the one or more processing units are configured to perform a method to display contents comprising a plurality of items, wherein performing the method comprises:
calculating a number of pages in which the plurality of items are divided;
creating a plurality of user interface elements, each user interface element assigned to a page;
determining a range information of each page, wherein the range information of the page indicates a start and end of a range of the items included on the page;
for each of the plurality of user interface elements, adding the range information of the page assigned to the user interface element;
combining two or more of the user interface elements into a representative user interface element in response to a number of the user interface elements exceeding a predetermined threshold; and
displaying the plurality of user interface elements, including the representative user interface element, with respective range information.

10. The system of claim 9, wherein the method further comprises displaying items of an Nth page.

11. The system of claim 10, wherein, in response to selection of a user interface element assigned to an Oth page, displaying items of the Oth page, and displaying, instead of the Nth page, a user interface element assigned to the Nth page.

12. (canceled)

13. The system of claim 9, wherein, in response to a selection of the representative user interface element, the two or more of the user interface elements are displayed.

14. The system of claim 9, wherein the range information for an Nth page is determined based on attributes of items on the Nth page, (N-1)th page, and (N+1)th page.

15. The system of claim 9, wherein the range information is adjusted to remove a portion of the range information before adding the range information to the user interface element.

16. The system of claim 9, wherein a first portion of the range information on the user interface element is displayed using first visual attributes, and a second portion of the range information is displayed using second visual attributes.

17. A computer program product comprising a computer-readable storage medium that has computer-executable instructions stored thereupon, the computer-executable instructions when executed by a processor cause the processor to perform a method to display contents comprising a plurality of items, wherein performing the method comprises:
calculating a number of pages in which the plurality of items are divided;
creating a plurality of user interface elements, each user interface element assigned to a page;
determining a range information of each page, wherein the range information of the page indicates a start and end of a range of the items included on the page;
for each of the plurality of user interface elements, adding the range information of the page assigned to the user interface element;
combining two or more of the user interface elements into a representative user interface element in response to a number of the user interface elements exceeding a predetermined threshold; and
displaying the plurality of user interface elements, including the representative user interface element, with respective range information.

18. The computer program product of claim 17, wherein the method further comprises displaying items of an Nth page, and in response to selection of a user interface element assigned to an Oth page, displaying items of the Oth page, and displaying, instead of the Nth page, a user interface element assigned to the Nth page.

19. (canceled)

20. The computer program product of claim 17, wherein the range information for an Nth page is determined based on attributes of items on the Nth page, (N-1)th page, and (N+1)th page.
